(19) United States
(12) Patent Application Publication
(10) Pub. No.: US 2023/0059307 A1
(43) Pub. Date: Feb. 23, 2023

(54) SYSTEM FOR DISTRIBUTING WASHER LIQUID

(71) Applicants: Hyundai Motor Company, Seoul (KR); Kia Corporation, Seoul (KR); DY AUTO Corporation, Asan-si (KR)

(72) Inventors: Jong Min PARK, Seoul (KR); Jin Hee LEE, Seoul (KR); Nak Kyoung KONG, Seongnam-Si (KR); Min Seok KIM, Anyang-Si (KR); Gyu Won HAN, Incheon (KR); Chan Mook CHOI, Incheon (KR); Ki Hong LEE, Seoul (KR); Seung Sik HAN, Hwaseong-Si (KR); Jong Wook LEE, Asan-Si (KR); Sin Won KANG, Asan-Si (KR); Jong Hyun JIN, Asan-Si (KR); Seong Jun KIM, Asan-Si (KR)

(73) Assignees: Hyundai Motor Company, Seoul (KR); Kia Corporation, Seoul (KR); DY AUTO Corporation, Asan-si (KR)

(21) Appl. No.: 17/889,825

(22) Filed: Aug. 17, 2022

(30) Foreign Application Priority Data
Aug. 23, 2021 (KR) 10-2021-0110938

(51) Int. Cl. B60S 1/48; B60S 1/50; B60S 1/52

(52) U.S. Cl. CPC B60S 1/481; B60S 1/50; B60S 1/52

(57) ABSTRACT

A system for distributing washer liquid includes at least one washer pump connected to a reservoir to pressurize the washer liquid, at least one distributor including at least one distribution unit fluidly connected to the washer pump, a plurality of nozzles fluidly connected to the at least one distribution unit in a distributor among the at least one distributor to face a cleaning target, and a controller configured to control opening or closing of the distribution unit formed in the at least one distribution unit and to control pressure of the washer pump.

### CROSS REFERENCE TO RELATED APPLICATION

The present application claims priority to Korean Patent Application No. 10-2021-0110938, filed Aug. 23, 2021, the entire contents of which is incorporated herein for all purposes by this reference.

### BACKGROUND OF THE PRESENT DISCLOSURE

### Field of the Present Disclosure

The present disclosure relates to a system for distributing washer liquid. More particularly, the present disclosure relates to a system for distributing washer liquid, which distributes washer liquid corresponding to a cleaning target requiring various flow rates through a distributor including a plurality of distribution units and at least one washer pump connected to the distributor.

### Description of Related Art

Conventionally, a washer pump system is mounted on a vehicle to selectively supply washer liquid stored in a washer tank to a front windshield or a rear windshield.

Because the surface of the windshield is frequently contaminated with foreign matter such as dust, it is necessary to remove the foreign matter from the windshield surface to secure a clear front view and promote safe driving.

To remove foreign matter from the windshield of the vehicle, the vehicle is provided with a wiper system as well as a washer nozzle for spraying washer liquid.

Therefore, when a driver manipulates a washer switch provided at a driver's seat to secure a clear view, a washer motor associated with the washer switch is operated, and washer liquid stored in a washer-liquid storage tank is sprayed through a washer nozzle onto a windshield by operating the washer motor. The sprayed washer liquid and the wiper operation remove the foreign substance interfering with the driving, thus allowing a driver to safely drive a vehicle while securing a clear view.

Recently, when contaminants are attached various devices (camera, radar, LiDAR, etc.) mounted on the outside of a vehicle for autonomous driving, it is important to maintain a measurable environment for performing the autonomous driving, and a flow rate and a pressure should be provided to spray washer liquid to various positions.

Therefore, there is a demand for a spray system intended to spray washer liquid having a sufficient flow rate and pressure for various cleaning targets.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a system for distributing washer liquid, which is configured for distributing washer liquid corresponding to various cleaning targets.

Furthermore, the present disclosure provides a system for distributing washer liquid, including a plurality of distributors or a plurality of washer pumps to secure the redundancy for the flow rate of the washer liquid and the redundancy for the distributor.

The present disclosure is not limited to the above-mentioned objective. Other objectives of the present disclosure may be understood from the following description, and may be realized by means described in claims and combinations thereof.

To achieve the objectives of the present disclosure, a system for distributing washer liquid is configured as follows.

The present disclosure provides a system for distributing washer liquid including at least one washer pump connected to a reservoir to pressurize the washer liquid; at least one distributor including at least one distribution unit and fluidly connected to the at least one washer pump; a plurality of nozzles fluidly connected to the at least one distribution unit in a distributor among the at least one distributor to face a cleaning target; and a controller configured to control opening or closing of the at least one distribution unit formed in the distributor, and to control pressure of the at least one washer pump.

The washer pump may include at least two or more washer pumps connected in parallel to each other, and each of the washer pumps may be coupled to at least one distributor.

The controller may be configured to operate another washer pump connected to the nozzle for the cleaning target, in response to a flow rate of the washer liquid required for the cleaning target or a failure of the washer pump coupled to the cleaning target.

The system may further include an inflow path to which a washer pump among the at least one washer pump and the distributor are coupled; a sub-path located between the distributor and another adjacent distributor among the at least one distributor; and a discharge path located between the distributor and the nozzle.

An internal diameter of the inflow path may be greater than an internal diameter of each of the sub-path and the discharge path.

An internal diameter of the sub-path may be greater than an internal diameter of the discharge path.

The cleaning target may include at least one of a windshield glass, a rear glass, a camera, a Light Detection and Ranging (LiDAR), and a radar.

The controller may be configured to determine a contamination level of the cleaning target, and may control to distribute the washer liquid from the distributor to the cleaning target, when the contamination level is equal to or greater than a reference value.

Each of the plurality of nozzles may be fluidly connected to the distribution unit, and the distribution unit may include a housing coupled to an adjacent distribution unit among the at least one distribution unit; a path passing through the housing and connecting the at least one distribution unit; a cover located at an outermost position of the housing to close the path; and a valve unit located at the path of the housing, and selectively opened or closed to distribute the washer liquid to the nozzle.

The distribution unit may include a main distribution unit located in a longitudinal direction of the path; and a sub-distribution unit located at a predetermined angle with the longitudinal direction of the path, and formed adjacent to the main distribution unit, and a discharge path of the sub-distribution unit may be configured to be fluidly connected to a discharge path of the main distribution unit.

The controller may be configured to determine a flow rate of the washer liquid supplied to the nozzle, and to selectively or simultaneously open the main distribution unit and the sub-distribution unit.

The distributor may include at least two distributors, and the distributors may be connected in parallel to each other.

The system may further include a main washer pump coupled to each of the at least two distributors; and a sub-washer pump provided adjacent to the main washer pump and selectively fluidly connected to each of the at least two distributors.

The system may further include a valve located between the sub-washer pump and the distributor, and the controller may be configured to control opening or closing of the valve in response to a failure of the main washer pump.

The present disclosure may obtain the following effects by the configuration, coupling, and use of embodiments.

According to an exemplary embodiment of the present disclosure, it is possible to provide a distributor that can selectively discharge a flow rate corresponding to a cleaning target, thus increasing a user's convenience.

Furthermore, it is possible to provide a distributor by coupling distribution units which may be coupled to each other, thus providing convenience of maintenance.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates a washer-liquid distributing system including one distributor, according to an exemplary embodiment of the present disclosure.

FIG. 2 illustrates a washer-liquid distributing system including two distributors, according to an exemplary embodiment of the present disclosure.

FIG. 3 illustrates a washer-liquid distributing system in which two washer pumps are coupled to one distributor, according to an exemplary embodiment of the present disclosure.

FIG. 4 illustrates a washer-liquid distributing system including one distributor, according to an exemplary embodiment of the present disclosure.

FIG. 5A illustrates a washer-liquid distributing system including one distributor, according to an exemplary embodiment of the present disclosure.

FIG. 5B is a side view exemplarily illustrating the coupling configuration of a plurality of distribution units, according to an exemplary embodiment of the present disclosure.

FIG. 6A illustrates a distributor including a main distribution unit and a sub-distribution unit, according to an exemplary embodiment of the present disclosure.

FIG. 6B is a side sectional view exemplarily illustrating a distributor including a main distribution unit and a sub-distribution unit, according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various embodiments of the present disclosure will be explained in detail with reference to the accompanying drawings. The present disclosure may be embodied in various forms and should not be construed as being limited to only the exemplary embodiments set forth herein. Embodiments of the present disclosure will be provided to make those skilled in the art more fully understand the present disclosure.

Furthermore, terms described in the specification, such as a “part”, a “unit”, or a “system”, mean a unit for processing at least one function or operation, which may be implemented in hardware or software or a combination of hardware and software.

It will be understood that terms “first”, “second”, “inflow”, “outflow”, “main”, or “sub” are only used to distinguish one component from another component, and are not intended to be limiting.

In the exemplary embodiment, terms “errors” or “failure” covers all cases in which a target cannot be driven in a normal state, and may include a case that hardware or a combination of hardware is not operated.

Hereinafter, various embodiments of the present disclosure will be described in detail with reference to the accompanying drawings. The same reference numerals are used throughout the drawings to designate the same or similar components.

The present disclosure is directed to a washer-liquid distributing system including at least one distributor 100 including a plurality of distribution units 110, and is directed to technology for selectively or simultaneously supplying washer liquid to a plurality of nozzles 300 that are fluidly connected to distribution units 110, respectively.

Moreover, to provide a preset flow rate and pressure of washer liquid supplied to the plurality of nozzles 300, it is possible to provide a fluid circuit configured so that washer pumps 200 are connected in series or in parallel, and a fluid circuit configured so that distributors 100 are connected in series or in parallel. Furthermore, the present disclosure pertains to an arrangement structure for solving the redundancy of the washer pump 200 and the distributor 100.

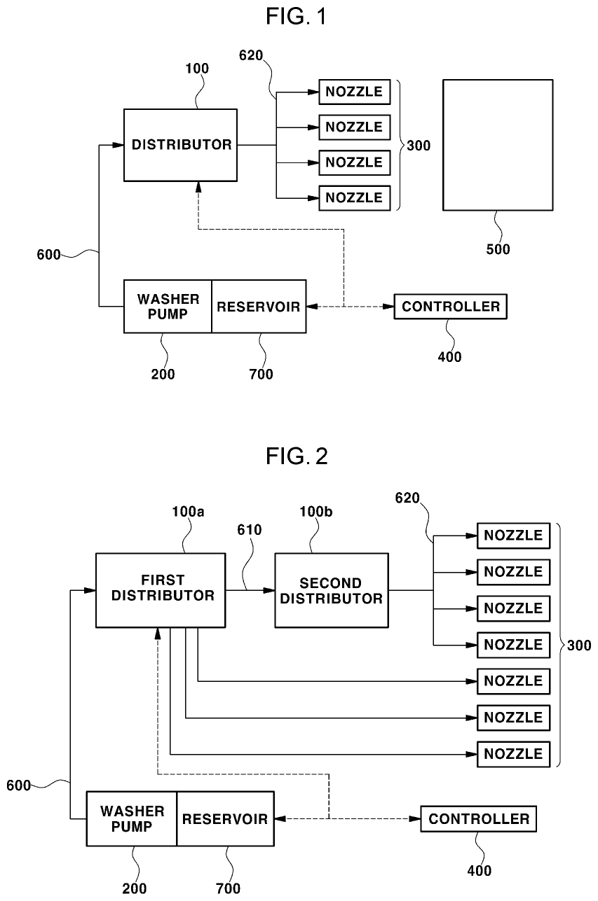

FIG. 1 illustrates the configuration of a washer-liquid distributing system according to an exemplary embodiment of the present disclosure. As shown in the drawing, the system includes a reservoir 700 that stores washer liquid, a washer pump 200 which is located at a discharge end portion of the reservoir 700 and applies a predetermined pressure to discharge washer liquid to an inflow path 600 fluidly connected to the distributor 100, and a level detector which is configured to measure the amount of the washer liquid in the reservoir 700.

The distributor 100 includes one or more distribution units 110, and each distribution unit 110 is configured to be fluidly connected to the nozzle 300 facing a cleaning target 500 through a discharge path 620. The washer-liquid distributing system forming the fluid circuit may include one or more distributors 100, and is configured so that distributors 100 are fluidly connected to each other via a sub-path 610.

The distribution unit 110 forming the distributor 100 defines a path 130 configured to pass therethrough, and adjacent distribution units 110 are sequentially located along the side of the distribution unit 110. Moreover, the path 130 defined in each distribution unit 110 is located to correspond to the path 130 of the distribution unit 110 located on the side of the distribution unit 110, thus being fluidly connected thereto.

According to an exemplary embodiment of the present disclosure, the cleaning target 500 may include at least one of a windshield glass, a rear glass, a camera located at a front or rear position or on the side of a vehicle, a Light Detection and Ranging (LiDAR), and a radar.

The controller 400 is configured to drive at least one washer pump 200 in response to a cleaning request, and to selectively open a valve unit 150 of each of the distribution units 110 forming the distributor 100. Therefore, when the valve unit 150 is opened, the washer liquid is transferred to the nozzle 300 through the discharge path 620 of the distribution unit 110.

Moreover, the controller 400 is configured to control the driving of a main distribution unit 110a and a sub-distribution unit 110b. When the failure of the main distribution unit 110a occurs or the flow rate of washer liquid which is to be transferred to the cleaning target 500 is greater than the flow rate of washer liquid which may be fed from the main distribution unit 110a, the sub-distribution unit 110b may be driven.

Furthermore, the controller 400 may determine the failure of the main washer pump 200a in an exemplary embodiment including the plurality of washer pumps 200, and may drive the sub-washer pump 200b to secure redundancy due to the failure of the main washer pump 200a.

Furthermore, when the controller 400 determines the contamination level of the cleaning target 500 and a contamination level is equal to or greater than a reference value, the controller may perform a control operation to spray washer liquid from the distributor 100 to the corresponding cleaning target 500. Furthermore, the flow rate or pressure of the sprayed washer liquid may be set, and the driving number of the washer pump 200 and the opening number of the distribution units 110 forming the distributor 100 may be determined depending on the set flow rate and pressure of the washer liquid.

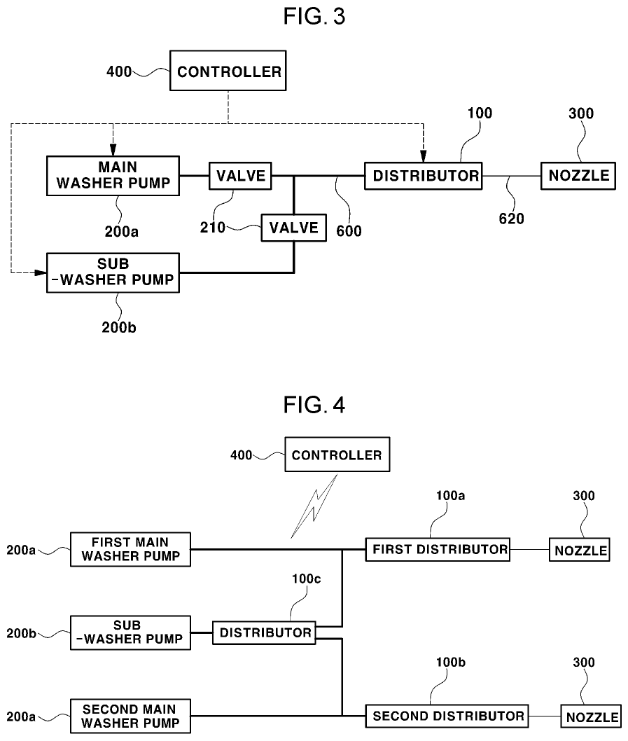

FIG. 2 illustrates an exemplary embodiment in which two different distributors 100 are coupled in series.

As shown in the drawing, washer liquid located in a reservoir 700 is configured to flow through an inflow path 600 of a distributor 100 into a first distributor 100a. The first distributor 100a includes a plurality of distribution units 110. At least some of the distribution units 110 forming the first distributor 100a are connected to nozzles 300 to be fluidly connected to a cleaning target 500. Furthermore, at least one of the distribution units 110 of the first distributor 100a is configured to be coupled to a second distributor 100b.

The second distributor 100b includes a plurality of distribution units 110, and is configured to spray washer liquid, introduced from the first distributor 100a, through the nozzle 300 to the cleaning target 500.

A controller 400 controls the opening and closing of the distribution units 110 forming the first distributor 100a, and separately or simultaneously controls the opening and closing of the distribution units 110 forming the second distributor 100b.

The internal diameter of a sub-path 610 configured to fluidly connect the first distributor 100a and the second distributor 100b is greater than the internal diameter of a discharge path 620 which is configured to couple the second distributor 100b to the nozzle 300, thus minimizing the loss of pressure.

Moreover, the internal diameter of the inflow path 600 configured to introduce washer liquid from the reservoir 700 into the first distributor 100a is greater than the internal diameters of the sub-path 610 and the discharge path 620, thus minimizing the pressure loss of the washer liquid transferred from the reservoir 700 to the nozzle 300.

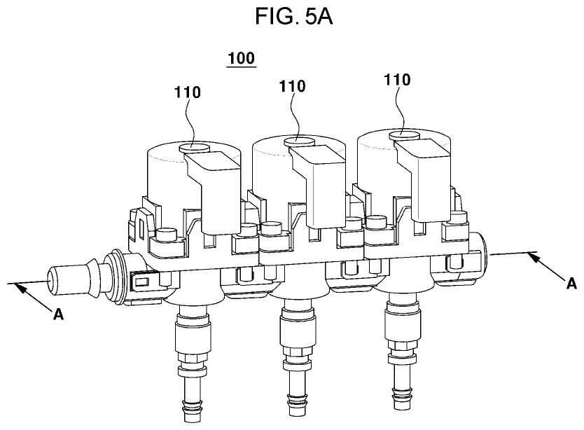

FIG. 3 illustrates a washer-liquid distributing system in which two washer pumps 200 are disposed in parallel, according to an exemplary embodiment of the present disclosure.

The washer-liquid distributing system may include a plurality of washer pumps 200 located in a reservoir 700. Referring to FIG. 3, the washer pumps may include a main washer pump 200a which is fastened to a distributor 100, and a sub-washer pump 200b that further includes a valve 210 located at the inflow path 600.

The controller 400 may be configured to control the driving of the main washer pump 200a and the sub-washer pump 200b, and be more preferably configured to open or close the valve 210 located at the inflow path 600 of the sub-washer pump 200b.

The controller 400 may be configured to detect the driving error or failure of the main washer pump 200a, and be configured to drive the sub-washer pump 200b in the inoperative state of the main washer pump 200a.

Moreover, when the pressure and flow rate of the washer liquid required by the distributor 100 exceed the driving amount of the main washer pump 200a even in the case where the main washer pump 200a may be driven, the controller 400 may control the driving of the sub-washer pump 200b.

In the present disclosure including two or more washer pumps 200, the controller 400 is configured to further perform the driving of the sub-washer pump 200b in response to the failure of the washer pump 200 or the flow rate and pressure of the washer liquid required for the cleaning target 500.

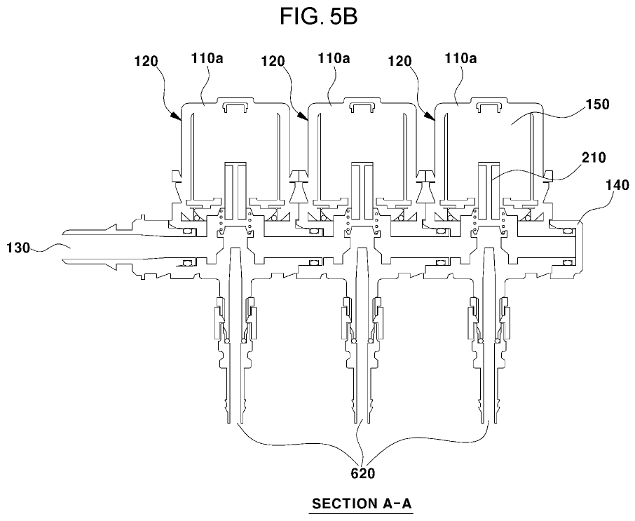

FIG. 4 illustrates a configuration in which one sub-washer pump 200b is included in two different fluid systems at which two washer-liquid distributors 100 are located respectively.

A first main washer pump 200a includes a first circuit which is fluidly connected to a first distributor 100a, and a second main washer pump 200a includes a second circuit which is fluidly connected to a second distributor 100b. The sub-washer pump 200b is configured to be selectively fastened to a first inflow path 600 and a second inflow path 600.

A valve 210 may be provided on a discharge end portion of the sub-washer pump 200b to optionally select a path 130. As shown in the drawing, a third distributor 100 may be located at the discharge end portion of the sub-washer pump 200b. Thus, the washer liquid discharged from the sub-washer pump 200b may be selectively fluidly connected to a discharge end portion of the first main washer pump 200a and/or a discharge end portion of the second main washer pump 200a, as the controller 400 controls the opening or closing of the third distributor 100.

In other words, a first circuit including the first distributor 100a and a second circuit including the second distributor 100b are disposed in parallel, and the sub-washer pump 200b including the third distributor 100c is located between the first circuit and the second circuit.

Therefore, in an exemplary embodiment including one sub-washer pump 200b, the sub-washer pump 200b may be connected through the third distributor 100c, located at the discharge end portion of the sub-washer pump 200b, to be selectively fluidly connected to the first circuit or the second circuit.

Thus, the controller 400 may secure redundancy depending on the failure of the first main washer pump 200a or the second main washer pump 200a. When the failure of the first main washer pump 200a or the second main washer pump 200a occurs, the sub-washer pump 200b is configured to supply the washer liquid to each of the first circuit and the second circuit. Furthermore, the sub-washer pump 200b may be selectively fluidly connected to the first circuit or the second circuit in response to the flow rate and pressure of the washer liquid required for the first circuit or the second circuit.

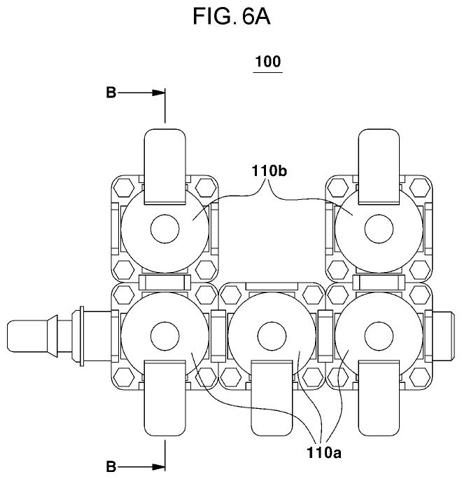

FIG. 5A illustrates a plurality of distribution units 110 forming the distributor 100 according to an exemplary embodiment of the present disclosure, and FIG. 5B illustrates a section taken along line A of FIG. 5A.

At least one distribution units 110 may be configured to be adjacent to each other. The nozzle 300 facing the cleaning target 500 is configured to be fluidly connected to the distribution unit 110. The distribution unit 110 includes a housing 120 configured to surround each distribution unit 110, and a path 130 configured to pass through the housing 120. Among the distribution units 110, the distribution unit 110 located at a first outermost end portion thereof is fluidly connected to the inflow path 600 to be connected to the path 130 defined in the housing 120. The path 130 defined in the distribution unit 110 is fluidly connected to the nozzle 300 through a discharge path 620.

A cover 140 is provided to close the external surface of the path 130 of the distribution unit 110 located at a second outermost end portion, among the distribution units 110, and is configured to seal an end portion of the path 130 passing through the interior of the housing 120. The cover 140 is located to be fixed to the housing 120, and a sealing member is provided inside the cover 140 to prevent the washer liquid introduced into the path 130 from leaking out of the housing 120.

The housing 120 may be fastened to an adjacent housing 120. Adjacent housings 120 are fixed to each other by welding, bolting or the like. A locking structure or an insert structure may be provided between the housing 120 of the distribution unit 110 and the housing 120 of the adjacent distribution unit 110 to increase a fastening force between the housings 120.

Each distribution unit 110 includes the valve 210, the opening or closing of which is controlled by the controller 400. The controller 400 is configured to open the valve 210 located at a position corresponding to a cleaning request and to spray the washer liquid in the housing 120 to the nozzle 300. The valve 210 may be a solenoid valve located in the housing 120.

The plurality of distribution units 110 may be located to be adjacent to each other in one direction thereof. As shown in the drawing, the distribution units may include the main distribution unit 110a located in a direction extending from the inflow path 600, and the sub-distribution unit 110b located to be adjacent to the main distribution unit 110a.

The sub-distribution unit 110b is configured to be fluidly connected to the discharge path 620 of the main distribution unit 110a. When the failure of the main distribution unit 110a occurs or the cleaning target 500 requires a large flow rate, the controller 400 is configured to open the valve 210 of the sub-distribution unit 110b.

Therefore, the system is configured to secure the redundancy of the main distribution unit 110a, or to provide a flow rate, which is equal to or greater than the flow rate of the washer liquid set for the main distribution unit 110a, to the cleaning target 500.

The path 130 defined in the distribution unit 110 may extend longitudinally along the inflow path 600, and may be fluidly connected to the sub-distribution unit 110b.

Furthermore, the housing 120 of the distribution unit 110 may be configured so that an end portion facing the path 130 is inserted into the housing 120 of an adjacent distribution unit 110, thus allowing adjacent distribution units 110 to be fluidly connected to each other. The housing may include at least one sealing member in an area where the path 130 is connected.

A valve unit 150 formed of the solenoid valve may be opened upwards or downwards, and may include an elastic unit that applies an elastic force in a direction opposite to the opening direction so that the opened valve unit 150 is restored to its original position.

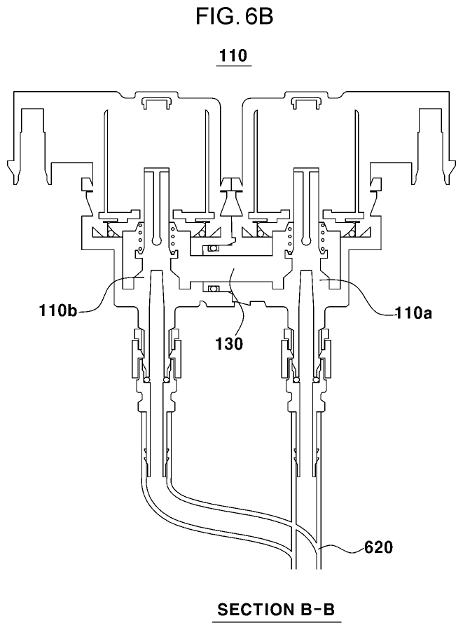

FIG. 6A illustrates a fastening relationship between the main distribution unit 110a and the sub-distribution unit 110b, and FIG. 6B illustrates a section taken along line BB of FIG. 6A.

A plurality of main distribution units 110a may be longitudinally disposed along the inflow path 600 to be coupled to each other, and a sub-distribution unit 110b disposed at a predetermined angle with respect to the longitudinal direction may be fastened to one or more main distribution units 110a.

As shown in the drawing, the sub-distribution unit 110b may be adjacent to at least one main distribution unit 110a to be perpendicular to a path 130 of the main distribution unit 110a. Moreover, the interior of the housing 120 of the sub-distribution unit 110b is configured so that the sub-distribution unit 110b is fluidly connected to the path 130 defined in the main distribution unit 110a.

The sub-distribution unit 110b may be fastened to the main distribution unit 110a that distributes a relatively larger flow rate to the cleaning target 500 or is fluidly connected to the cleaning target 500 essentially applied to driving environment.

In other words, the path 130 located around the housing 120 of the main distribution unit 110a with respect to an end portion of the discharge path 620 defined in the housing 120 of the main distribution unit 110a is fastened to the path 130 defined in the sub-distribution unit 110b. Moreover, the discharge path 620 of the sub-distribution unit 110b is configured to be fluidly connected to the discharge path 620 of the main distribution unit 110a. When the valve unit 150 of the sub-distribution unit 110b is opened, the washer liquid is discharged to the nozzle 300 for the cleaning target 500, which is fluidly connected to the discharge path 620 of the main distribution unit 110a.

Because the controller 400 may determine whether the failure of the main distribution unit 110a occurs and may measure the flow rate of the washer liquid sprayed to the cleaning target 500, the controller may open the main distribution unit 110a in response to the request of the cleaning target 500. Alternatively, the controller 400 may open the sub-distribution unit 110b in response to the failure of the main distribution unit 110a. Furthermore, when the flow rate of the washer liquid for the cleaning target 500, which is more than the flow rate from the main distribution unit 110a, is required, the sub-distribution unit 110b is opened to provide a required flow rate.

As described above, the present disclosure includes at least one distributor 100 including the plurality of distribution units 110, and provides the fluid circuit in which at least one washer pumps 200 are connected in series or in parallel, so it is possible to provide the washer-liquid distributing system which may provide the redundancy of the distributor 100 or the washer pump 200 and may easily spray the washer liquid to a plurality of cleaning targets 500 in various environments.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the control device may be implemented in a form of hardware or software, or may be implemented in a combination of hardware and software.

Furthermore, the terms such as “unit”, “module”, etc. Included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of predetermined exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A system for distributing washer liquid, the system comprising:
at least one washer pump connected to a reservoir to pressurize the washer liquid;
at least one distributor including at least one distribution unit and fluidly connected to the at least one washer pump;
a plurality of nozzles fluidly connected to the at least one distribution unit in a distributor among the at least one distributor to face a cleaning target; and
a controller configured to control opening or closing of the at least one distribution unit formed in the distributor, and to control pressure of the at least one washer pump.

2. The system of claim 1, wherein the at least one washer pump includes at least two or more washer pumps connected in parallel to each other, and each of the at least two or more washer pumps is connected to the distributor.

3. The system of claim 2, wherein the controller is configured to operate another washer pump connected to the plurality of nozzles for the cleaning target, among the at least two or more washer pumps, in response to a flow rate of the washer liquid required for the cleaning target or a failure of a washer pump coupled to the cleaning target among the at least two or more washer pumps.

4. The system of claim 1, further including:
an inflow path to which a washer pump among the at least one washer pump and the distributor are coupled;
a sub-path located between the distributor and another adjacent distributor among the at least one distributor; and
a discharge path located between and directly connected to the distributor and the plurality of nozzles.

5. The system of claim 4, wherein another adjacent distributor and the distributor are connected in series.

6. The system of claim 5, wherein the distributor is connected to a predetermined number of the plurality of nozzles and another adjacent distributor is connected to a remaining number of the plurality of nozzles

7. The system of claim 4, wherein an internal diameter of the inflow path is greater than an internal diameter of each of the sub-path and the discharge path.

8. The system of claim 4, wherein an internal diameter of the sub-path is greater than an internal diameter of the discharge path.

9. The system of claim 1, wherein the cleaning target includes at least one of a windshield glass, a rear glass, a camera, a Light Detection and Ranging (LiDAR), and a radar.

10. The system of claim 1, wherein the controller is configured to determine a contamination level of the cleaning target, and to control to distribute the washer liquid from the distributor to the cleaning target, when the contamination level is equal to or greater than a reference value.

11. The system of claim 1,
wherein each of the plurality of nozzles is fluidly connected to the distribution unit, and
wherein the distribution unit includes:
a housing coupled to an adjacent distribution unit among the at least one distribution unit;
a path passing through the housing and connecting the at least one distribution unit;
a cover located at an outermost position of the housing to close the path; and
a valve unit located at the path of the housing, and selectively opened or closed to distribute the washer liquid to the plurality of nozzles.

12. The system of claim 11, wherein the at least one distribution unit includes:
a main distribution unit located in a longitudinal direction of the path; and
a sub-distribution unit located at a predetermined angle with the longitudinal direction of the path, and formed adjacent to the main distribution unit, and
wherein a discharge path of the sub-distribution unit is configured to be fluidly connected to a discharge path of the main distribution unit.

13. The system of claim 12, wherein the controller is configured to determine a flow rate of the washer liquid supplied to the plurality of nozzles, and to selectively or simultaneously open the main distribution unit and the sub-distribution unit.

14. The system of claim 1, further including:
a main washer pump coupled to the distributor;
a sub-washer pump connected to the distributor in parallel to the main water pump; and
at least a valve mounted between the main washer pump and the distributor or between the sub-washer pump and the distributor,
wherein at least one of the main washer pump and the sub-washer pump is selectively fluidly-connected to the distributor by operation of the at least a valve.

15. The system of claim 1, wherein the at least one distributor includes at least two distributors, and the at least two distributors are connected in parallel to each other.

16. The system of claim 14, wherein the at least one pump includes:
a main washer pump coupled to each of the at least two distributors; and
a sub-washer pump provided adjacent to the main washer pump and selectively fluidly connected to each of the at least two distributors.

17. The system of claim 15, further including an additional distributor connected to the sub-washer pump and to the at least two distributors.

18. The system of claim 16, further including:
a valve located between the sub-washer pump and the distributor,
wherein the controller is configured to control opening or closing of the valve in response to a failure of the main washer pump.

19. The system of claim 16, further including:
a second main washer pump connected to the at least two distributors
